(19) United States
(12) Patent Application Publication
(10) Pub. No.: US 2008/0195600 A1
(43) Pub. Date: Aug. 14, 2008

(54) EFFICIENT METHOD AND PROCESS TO SEARCH STRUCTURED AND UNSTRUCTURED PATIENT DATA TO MATCH PATIENTS TO CLINICAL DRUG/DEVICE TRIALS

(76) Inventor: Daniel R. Deakter, (US)

Correspondence Address: DANIEL R. DEAKTER, M.D, 8281 HAMPTON WOOD DRIVE, BOCA RATON, FL, 33433, US

(21) Appl. No.: 11/753,341

(22) Filed: May 24, 2007

Related U.S. Application Data
(63) Continuation-in-part of application No. 10/567,534, filed on Aug. 17, 2006.
(60) Provisional application No. 60/803,233, filed on May 25, 2006.

(51) Int. Cl. G06F 7/06; G06Q 50/00; G06F 17/30

(52) U.S. Cl. 707/5; 705/3; 707/E17.017; 707/E17.005

(57) ABSTRACT

A method and system that automatically matches patients to clinical drug and device trials with: a database component operative to maintain a hospital/RHIO/medical practice patient database and their corresponding medical records, and a medical practice database and their corresponding plurality of specialties, and a clinical studies database component and their corresponding plurality of clinical studies a communications component to receive changes to the database component and a processor programmed to: periodically match compatible patients and clinical studies and generate reports to matched medical practices in the medical practice database having matched patients. The processor may be programmed to more efficiently function by selecting key rare criteria first in order to search free text keywords and phrases last.

### CROSS REFERENCE TO RELATED APPLICATIONS

This application claims the benefit of U.S. Provisional Application 60/803,233 filed May 25, 2006 and is a continuation-in-part of U.S. patent application Ser. No. 10/567,534, filed Mar. 11, 2004 which claims the benefit of U.S. Provisional Application No. 60/453/680 filed. Mar. 11, 2003.

### TECHNICAL FIELD

The present invention relates to drug and device clinical trials and, more particularly, to expand the pool of available candidates and efficiently identify potential entrants.

### BACKGROUND ART

This invention relates generally to the field of clinical research and more specifically to a method and system that automatically matches patients to clinical drug or device trials. 94% of all clinical drug research trials are delayed one month or more costing the Sponsor an average of $47 million dollars.

As the number of elderly people increases in the United States and their lifespans extend, there is an ever-increasing need for newer and safer pharmaceutical products. As such, there is a need for new drugs and medical devices to be approved more rapidly. With the mapping of the human genome it is estimated that drug targets and drugs will multiply tenfold, necessitating more clinical testing. In fact, The Pharmaceutical Research and Manufacturers of America (PHRMA) states that all drugs currently on the market are based on about 500 different targets. They expect this number to increase 600-2000%, to 3,000 to 10,000 drug targets in the coming years. However, such medical advances are outrageously expensive and have necessitated changes throughout the industry.

It is estimated to cost $880 million to bring one new drug to market, and it is estimated that the average pharmaceutical company has 70 new drugs in development. This has forced the pharmaceutical companies to consolidate for the purpose of underwriting the prohibitive expense of bringing a drug to market. The average drug takes 10 to 12 years to bring to market and must negotiate a series of 3 clinical trials before approval by the Food and Drug Administration (FDA) can even be granted, leaving 8 to 10 years on a drug patent to recoup costs and turn a profit. Factoring in the governmental and managed care cost containment pressures, the pharmaceutical companies must produce one blockbuster medicine every 18 months to survive.

The Federal Government has recently pushed for the adoption of Electronic Medical Records. In addition over the past few years there have been the establishments of Regional Healthcare Information Organizations (RHIO) which exist to allow practitioners access to their patient's records in hospitals and doctor's offices not related to them. The anticipated effect is to create efficiencies in the medical industry by reducing duplication and medical errors.

In summary, the pharmaceutical companies are in a position where they are producing more new drug compounds than ever before; they are about to lose the patents on many of their highly profitable, blockbuster, drugs; and they are being squeezed by the managed care industry. It is therefore critical for the pharmaceutical companies to discover, test and market the maximum number of new drugs in the minimum amount of time.

In order to speed up this process, business efficiencies are being applied to the previously haphazard clinical trials process. According to a Tufts University study, each day a study is late a pharmaceutical company can lose $1.3 million in lost prescription drug sales and it can be as high as $10 million for a blockbuster drug. Clinical trials are for the most part paper-based; necessarily cumbersome; and slow to monitor, process and store. One of the key factors affecting the time it takes to complete a clinical trial or study is the time it takes to recruit, screen and refer patients to the study. Only when the study is completely populated with patients can testing begin. Currently, the haphazard methods to recruit patients can take up to a year and 25% of the duration of the clinical study and thus, it becomes no surprise that 75% of all clinical studies are completed late.

There are a number of web-based clinical trial management software programs which plan, administer, and process trials for pharmaceutical companies.

Traditionally, patients for studies have been enrolled from an investigator's clinic or practice, via referrals or by advertising. One prior art publication that addresses this problem using the Internet, is “Systems and Methods for Selecting and Recruiting Investigators and Subjects for Clinical Studies”.

In U.S. Pat. App. Pub. No. 2002/0002474 by Leslie Dennis Michelson and Leonard Rosenberg Michelson and Rosenberg utilize an online web-based system to screen and enroll investigators and patients, and match patients to an appropriate investigator by zip code. Another prior art publication is entitled, “Recruiting A Patient Into A Clinical Trial”, U. S. Pat. Application Pub. No. 2002/0099570 by Knight.

Basically, Knight discloses how a patient with a particular disease may find a relevant study using a computer, a web browser and an Internet connection.

Otherwise, the need for recruiting patients is served by databases of patients available for drug trials, or by programs that flag key words on dictated summaries using a search engine for evaluation for eligibility in studies, or by web-based patient enrollment programs. There are a number of websites where patients may do a preliminary application for eligibility and thereby enroll by this means.

These publications, however, do not utilize data as close to realtime as possible. They also do not systematically search all available places that patients may be found for drug trial enrollments. In particular, those websites that deal only with investigators comprise only 5% of all physicians, and a corresponding number of patients. Both Knight's and Michelson's methods do not systematically search for and find patients and they do not solve the problem of searching huge unstructured databases. It is believed that none of the known systems have a way to tap into the 95% of non-research preforming physicians to find and enroll their patients into studies.

A method that searches dictations and flags patients may be used in the offices of physicians with large practices who do research. These physicians are then paid for each patient found and for administering the study on that patient.

However, these physicians are usually specialists who depend on referrals and it may take months for newly diagnosed patients to see the specialist and they comprise about 5% of the physician population.

Rao et al. describe methods for mining patient data in U. S. Pat. App. Pub. Nos. 2003/0120458 and 2003/0130871. However, the methods of Rao et al. require the calculation of probability-based inferences of matching patients to clinical trials and not on direct matching of trial criteria with suitable patients and the assignment of values to calculate probabilities are arbitrary and not reflective of actual clinical decision making which is generally used to enroll patients into studies.

These publications, however, do not utilize data as close to realtime as possible. They also do not systematically search all available places that patients may be found for drug trial enrollments. In particular, those websites that deal only with investigators comprise only 5% of all physicians, and a corresponding number of patients. Both Knight's and Michelson's methods do not systematically search for and find patients. It is believed that none of the known systems have a way to tap into the 95% of non-research performing physicians to find and enroll their patients into studies.

A method that searches dictations and flags patients may be used in the offices of physicians with large practices who do research. These physicians are then paid for each patient found and for administering the study on that patient.

However, these physicians are usually specialists who depend on referrals and it may take months for newly diagnosed patients to see the specialist and they comprise about 5% of the physician population.

These methods also do not order search parameters to minimize the amount of text searching.

Therefore, based upon the foregoing, there is a need for a process that will tap a larger pool of patients more systematically, using data as close to realtime as possible with a level of precision not previously found and that will identify prospective patients at an earlier stage of their ailment before they see the appropriate specialist, to widen their treatment options.

### SUMMARY OF THE INVENTION

In light of the foregoing, it is a first object of the invention to provide a system to rapidly and precisely identify patient candidates for clinical trials comprising: a database component operative to maintain a hospital patient database component and its plurality of hospital databases and their corresponding plurality of patient names and medical records, and a medical practice database and their corresponding plurality of specialties and their corresponding plurality of patient names and medical records, and a clinical studies database component and its corresponding plurality of clinical studies; a communications component to receive changes to said database component; a communications component to receive changes to said database component; and a processor programmed to periodically match compatible patients and clinical studies, and to generate reports to matched medical practices in said medical practice database.

It is another object of the invention to provide a computerized method for matching patients to clinical medical studies, comprising: identifying a group of medical practices; identifying at least one clinical study; identifying a group of patients from a hospital database; maintaining a database identifying each said medical practice and each patient of said group of patients from said hospital database and each said clinical study; and comparing said medical practices and said clinical studies and matching one to the other.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed, a system for automatically matching patients to clinical trials comprising: a database component operative to maintain: one or more hospital patient database components and their one or more hospital databases and their corresponding plurality of patient names and their medical records, wherein the hospital patient database components are in communication with one or more medical practice database components and their corresponding plurality of specialties and their corresponding plurality of patient names and their medical records; a clinical studies database component and its corresponding plurality of clinical studies; a communications component to receive changes to said database component; and a processor programmed to periodically match compatible patients and clinical studies without reliance on calculation of probability-based inferences of matching, and generate reports to matched medical practices in said medical practice database component having one or more patients matched to at least one clinical study

In accordance with a preferred embodiment of the invention, there is disclosed a computerized method for matching patients to clinical medical studies comprising: identifying a group of patients in a hospital database; identifying at least one clinical study: maintaining a database identifying each said patient in said hospital database and each said clinical study; and comparing said group of patients in said hospital database to said clinical studies and matching one or more patients in a hospital database to one or more clinical trials without reliance on calculation of probability-based inferences of matching.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of an Overall Schema of parts of the Invention;

FIG. 2 is a perspective view of the Identifier;

FIG. 3 is a perspective view of a Flow diagram of the process;

FIG. 4A is a perspective view of a Process to classify eligibility criteria;

FIG. 4B is a perspective view of a Process to assign frequencies to each of the criteria;

FIG. 4C is a perspective view of a Process to prioritize the criteria based on frequencies;

FIG. 4D is a perspective view of a Flow chart for determining the search order based on templates;

FIG. 5A is a perspective view of a Flow chart of search criteria order for a study that can utilize lab criteria initially;

FIG. 5B is an exploded view of a Flow Chart of step 424A of FIG. 5A;

FIG. 5C is a perspective view of Flow Chart of Text Based Key eligiblity criteria for study;

FIG. 5D is an exploded view of a Flow Chart of step 424C of FIG. 5C;

FIG. 5E is a perspective view of a Flow Chart for search based on physiological key criteria;

FIG. 5F is an exploded view of a Flow Chart of step 446E of FIG. 5E;

FIG. 5G is a perspective view of a Flow Chart for genetic criteria;

FIG. 5H is a an exploded view of a Flow Chart of step 424G of FIG. 5G;

FIG. 5I an exploded view of a Flow Chart of step 434G of FIG. 5G; and

FIG. 6 is a perspective view of a Flow chart of string matching of text criteria.

For purposes of clarity and brevity, like elements and components will bear the same designations and numbering throughout the FIGURES.

### Best Mode for Carrying out the Invention

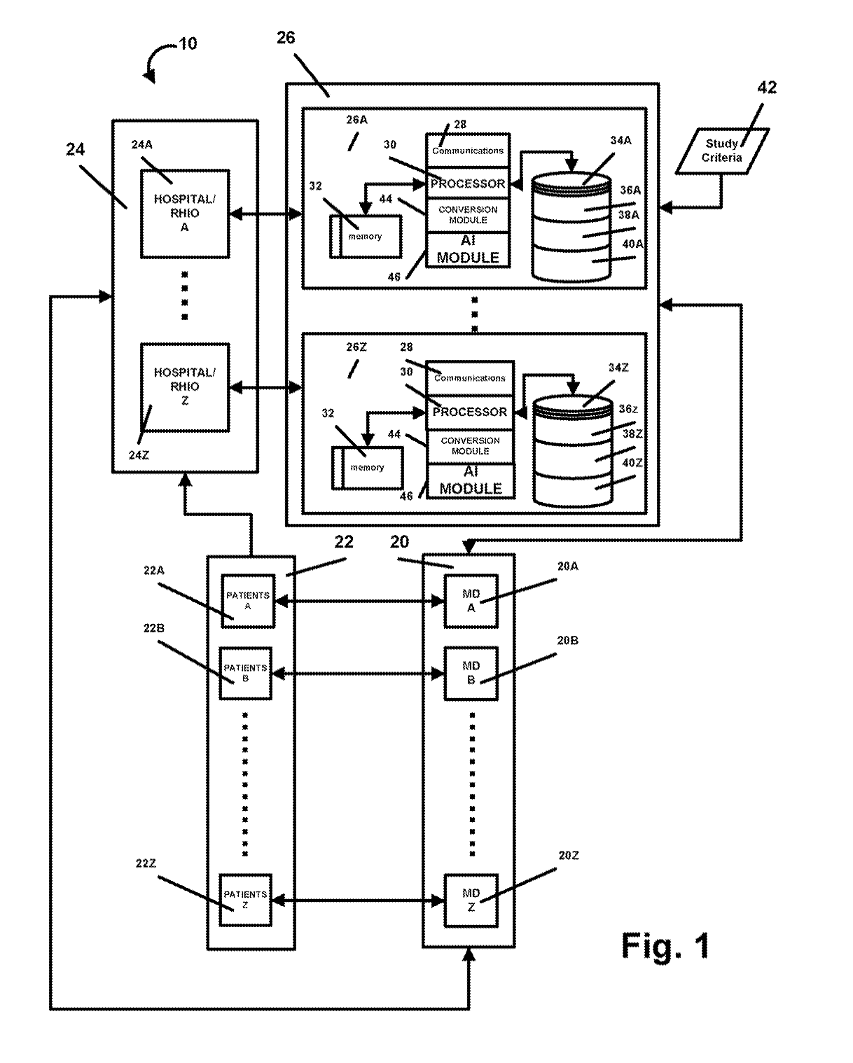

FIG. 1 is a perspective view of an Overall Schema of parts of the Invention. Referring now to FIG. 1 it can be seen that a system and related method for identifying patients for enrollment into a clinical trial is generally designated by the numeral 10. The system includes various organizations or entities that cooperate with one another for the purpose of identifying patients to be enrolled in medical studies. As discussed previously, sponsors of clinical trials, in order to eliminate bias from clinical testing, have to outsource their research to outside entities that actually do the research. One of the first steps to perform the trial is to find and enroll patients. One of the sources for finding patients are medical practices generally designated by the numeral 20 wherein any number of specific medical practices are provided with an alphabetic suffix. The patient population for each medical practice is generally designated by the numeral 22 and specifically each practice has a corresponding patient population each designated by a corresponding alphabetic suffix. These patient populations may be accessed through one or more Hospital/RHIOs to which the patients are referred. Optionally, patient populations may be accessed through the Hospital/RHIOs without reference to a referring medical practice. The Hospital/RHIOs are generally designated by the numeral 24 with each individual Hospital/RHIO represented by alphabetic suffixes. In the preferred embodiment of this invention, there is an identifier generally designated by the numeral 26 and specifically one associated with each Hospital/RHIO and designated by the same alphabetic suffix as its corresponding Hospital/RHIO. The identifier consists of a communications component 28 capable of receiving and sending communications in any number of forms, including but not limited to facsimile, page, email, voice text, website data entry and instant messaging. The identifier 26 includes a computer processor 30 which includes the necessary hardware, software and memory to implement the system and methodologies disclosed herein. The processor 30 is programmed, using a Conversion Module 44, to convert database information from incompatible operating systems to the operating system data types used by the processor. The processor 30 is programmed to load the eligibility criteria, implement a best search strategy based on PRIORITIZATION of search criteria, utilizing the AI Module 46 also disclosed herein, and to output a report of matched patient clinical study and physicians. Moreover, each processor 30 is designed to access a database 34 each of which is designated by the same alphabetic suffixes as its corresponding Hospital/RHIO. The database comprises a studies database component 36, which contains the eligibility criteria for all the studies ; a patient database component 38, also designated by the same alphabetic suffix as its corresponding Hospital/RHIO, containing clinical and demographic information that is a duplicate of the corresponding Hospital/RHIO database; and a physician database component 40, also designated by the same alphabetic suffix as its corresponding Hospital/RHIO, and comprising a plurality of medical practices. The processor 30 and communications component 28 are operative to maintain and update the database components. The selection process begins when clinical study criteria are transmitted to the communications component 28 of identifier 26.

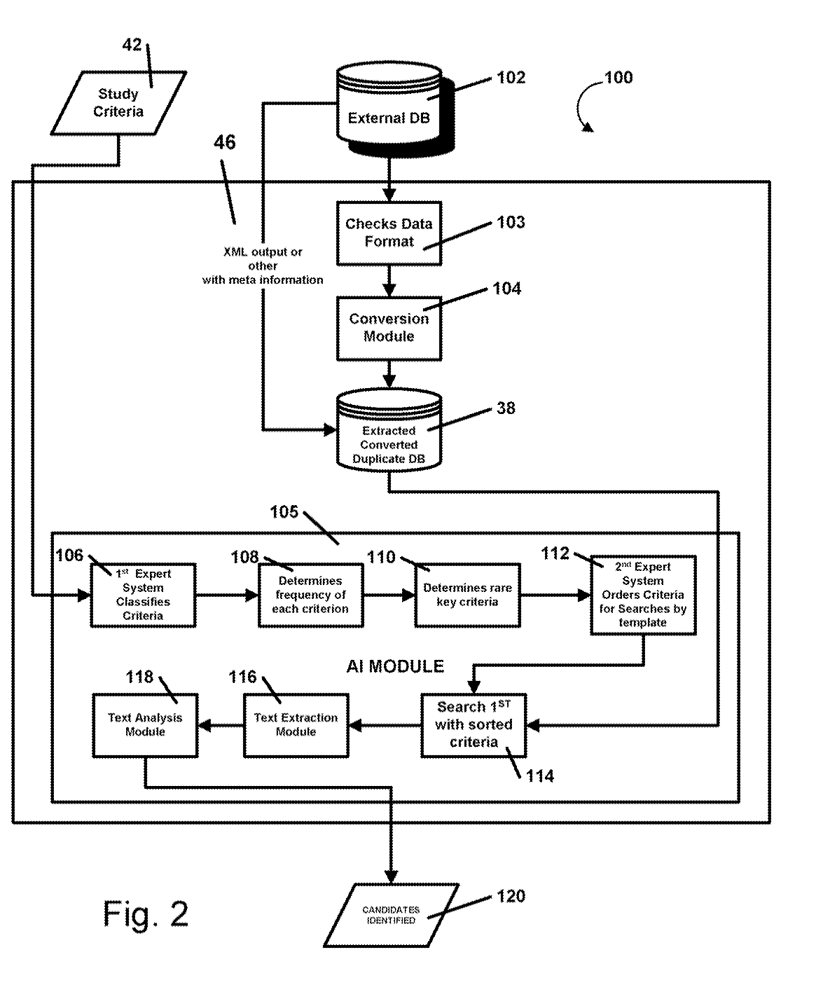

FIG. 2 is a perspective view of a The identifier. Referring now to FIGS. 1 and 2, the AI Module 46 and the process by which it is used in implementing system 10, is generally designated by the numeral 100. The external database information from Hospital/RHIOs 24 is input into the identifier 26 at step 102. At step 103, the processor 30 evaluates the data to determine if it is in a compatible format. If it is incompatible, the processor uses the conversion module 44 at step 104 to convert the data to a compatible format, such as conversion of 64 bit data from a VMS operating system to UNIX/LINUX 64 or Windows OS 32 or 64. In either case, compatible data is then used to populate the various tables within the database 34. The conversion module employs a software emulator or other program which reads and converts files from one operating system to another to change the format of the data into a compatible format. The converted data files are then input into an extracted converted database at step 38, which is a duplicate of the information from each Hospital/RHIO 24. Alternatively the data from 102 may be extracted as XML output with meta information attached and this would be inputted into the extracted converted DB 38. The study criteria 42 are input into the AI module 46 and in particular to a First Expert System at step 106, which classifies the criteria or it may use a lookup table of previously classified criteria or a neural net or other artificial intelligence (AI) method. These criteria are subsequently assigned a frequency at step 108, which may be done by taking the number of instances that criteria is found in the database and dividing it by the total number of instances of all the criteria in the database or alternatively it can be set manually. Step 110 next determines the rarest key criteria. It will be that criteria which is sufficiently rare so as to exclude most of the other records in the Database to hone in on the subset that likely will contain the matches sought, and that is also easily searchable, such as a lab value or marker, an ICD 9 or 10 code or a medication which will be specific to the disease entity sought. The criteria is then input into a Second Expert System 112 which sorts the order of the criteria to search more efficiently according to one of several templates, (this is because different diseases have different diagnostic criteria, some have specific lab values, others markers and yet others have physiological or function parameters). At step 114, the search begins utilizing the prioritized criteria list templates. The output of step 114 is a reduced subset of patients of the database, which is then searched for specific text strings in specific places of various records at step 116 to minimize the number of records, analyzed at 118 the analysis is performed on unstructured text to pick up any other diagnostic information, find any other inclusions or exclusions and to verify the other data for accuracy prior to outputting a match at 120. This is the most compiler/CPU intensive part of the process and is, therefore, the last step before final matches are output, as the pool of candidates has, at this point, been MAXIMALLY reduced. The text analysis increases the precision of the search process by extracting and processing data from text not revealed by the previous steps. The text analysis module may use semantic processing, contextual extraction, semantic networks, neural networks and the like. VISUALTEXT (TEXT Analysis International, Inc., Sunnyvale, Calif.) and similar natural language text analysis software is suitable for use as a text extraction module. This module 118 may be used to extract patient information from text such as histories and physicals, operative notes, pathology and radiology reports and the like. VISUALTEXT”CAN scan a typical text document in about 0.25 seconds, and hence, should optimally be used as the last step in the search process for obtaining precise results as quickly as possible. For example, for a database having a size of 350 gigabytes, it is estimated that a text search of the entire database would take approximately 40 hours. However, if text searching is performed last in a series of inclusion AND/OR exclusion criteria, the text search is estimated to take approximately 90 minutes. The output at step 120 consists of the candidates identified for potential entry into clinical trials.

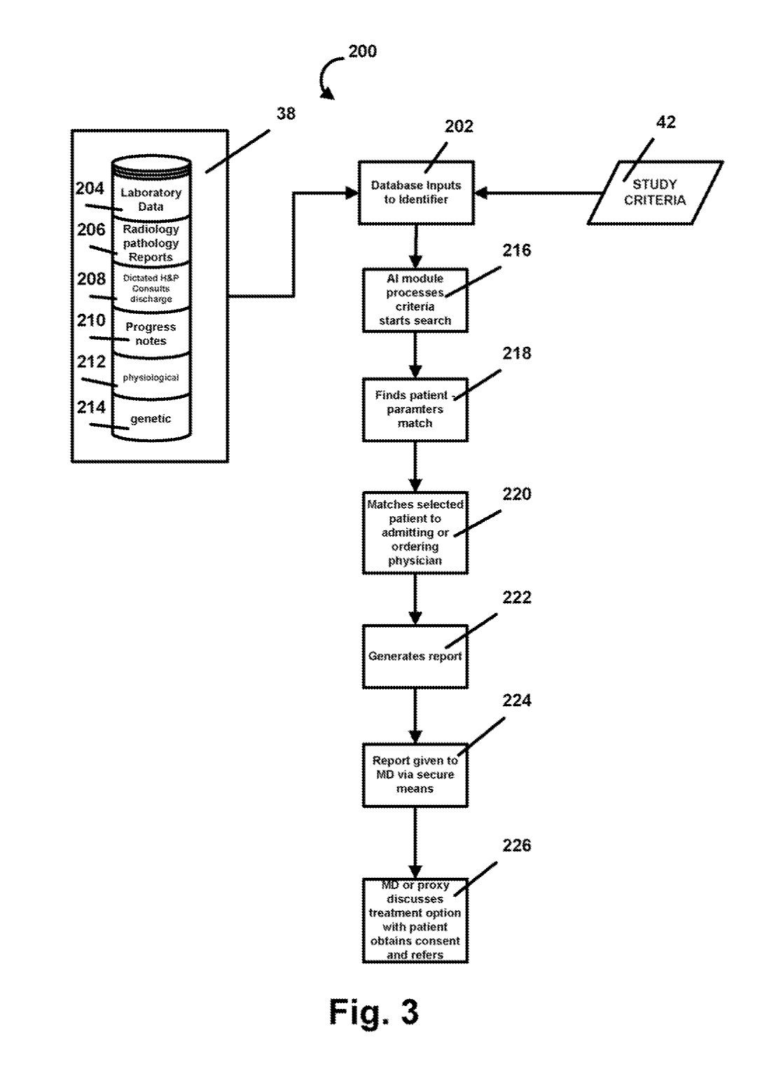

FIG. 3 is a perspective view of a Flow diagram of the process. The process which is used in implementing system 10 may be further illustrated in FIG. 3, and generally designated by the numeral 200. The process utilizes the following steps to match patients to clinical studies. At step 202, the study criteria 42 are input into the database 38 of the identifier 26. The database typically includes such components as a laboratory result database component 204, a radiology and pathology report database component 206, dictated history and physical database component 208, dictated progress notes database component 210, physiological studies database component 212 which may include, but are not limited to, pulmonary function studies, cardiac catheterizaions, electrocardiogram results, cardiac stress tests, esophageal manometry, hysterosalpingogram, bladder capacity test, nerve conduction tests and the like. The database may also include a genetic database component 214, which contains identified genes which are needed for studies that correct a disease caused by deficient gene. At step 216, the AI Module processes the criteria and searches the extracted database. At step 218, the processor 30 finds matches between the study criteria parameters and the patients. At step 220, selected patient study matches are paired with the admitting or ordering physician. The processor can be programmed to choose matches of 100% of criteria or another variable preset percentage. A report is generated at step 222 which may contain: patient name, title of the study that the patient quantifies for, a listing of the criteria that the patient has met and any criteria not met, if any, and the name of the admitting or ordering physician. Step 224 utilizes the communications component 28 and transmits a report to the physician via secure means, which includes but is not limited to encrypted email, restricted personalized web page or sealed confidential envelopes handed to physician by a specially cleared person at the Hospital/RHIO similar to the current mechanism that confidential HIV results are transmitted to physicians in the Hospital/RHIO in accordance with the Privacy Rules of The Health Insurance Portability Act. Then, at step 226, the physician may verify the accuracy of the criteria, discuss treatment options with his or her patient, and obtain consent either to enroll the patient into a study or to refer the patient to a research site that does the study.

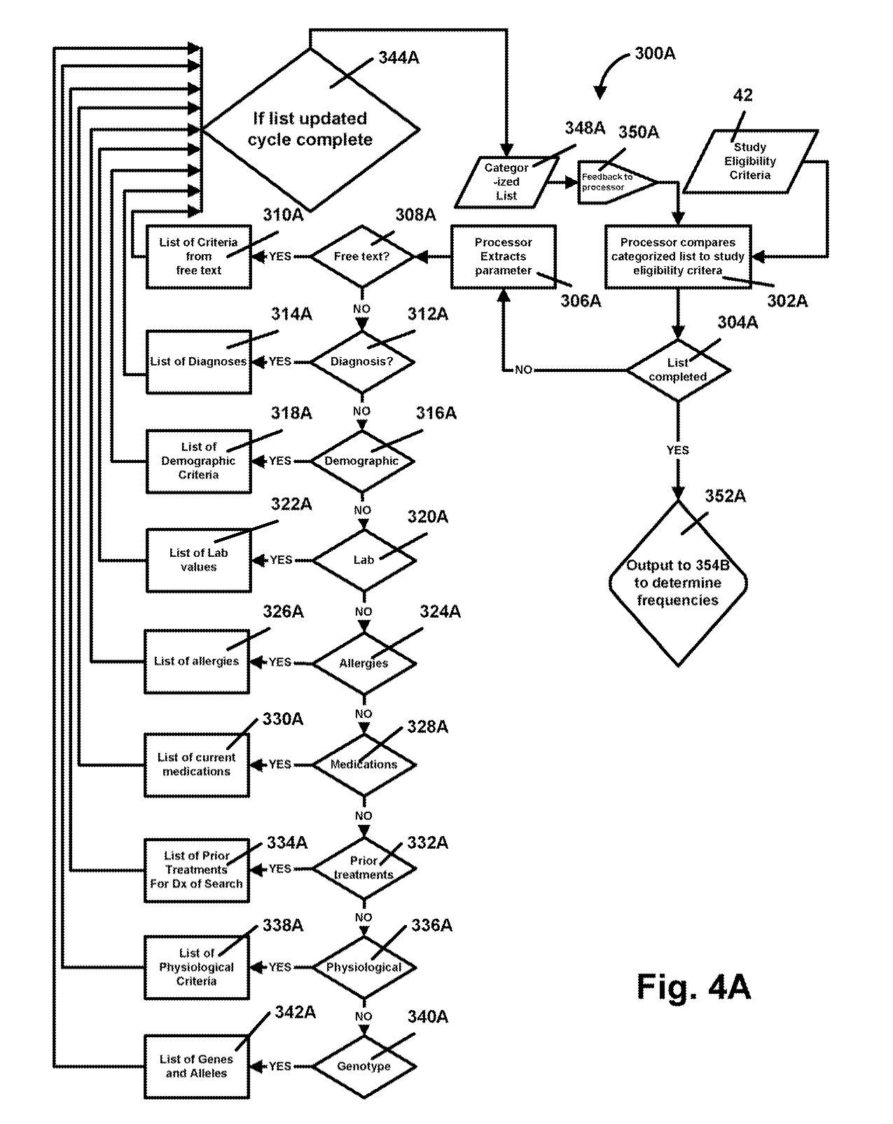

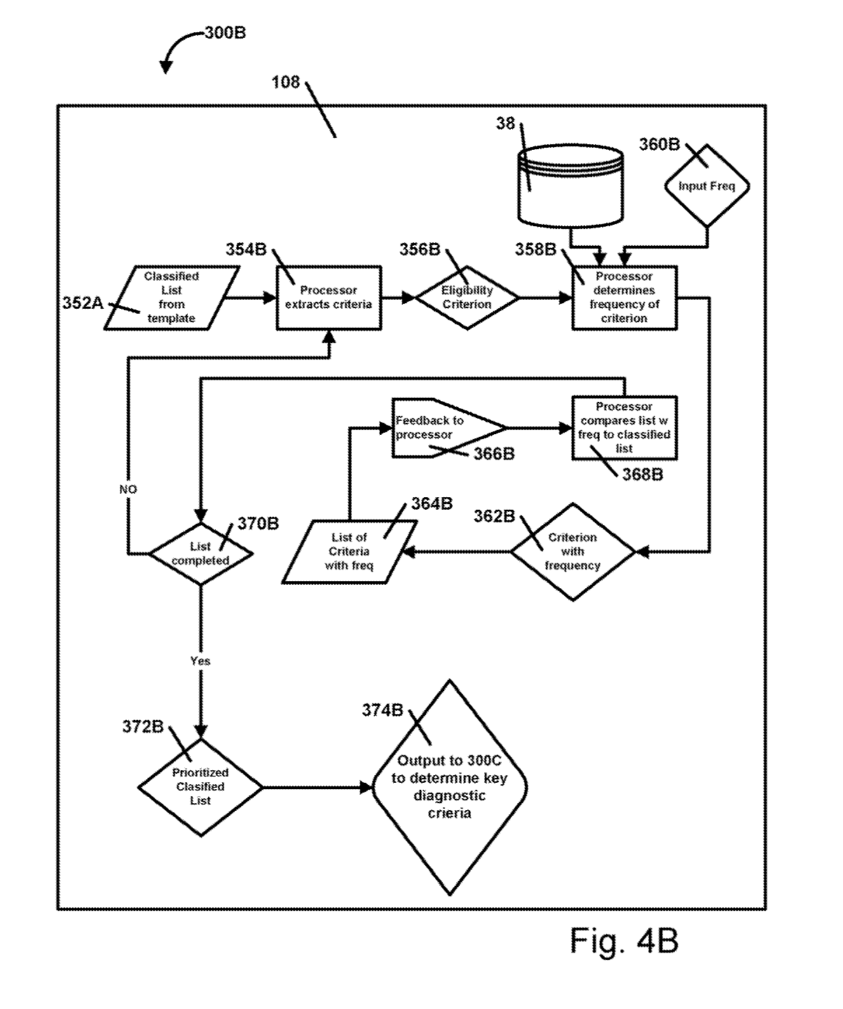

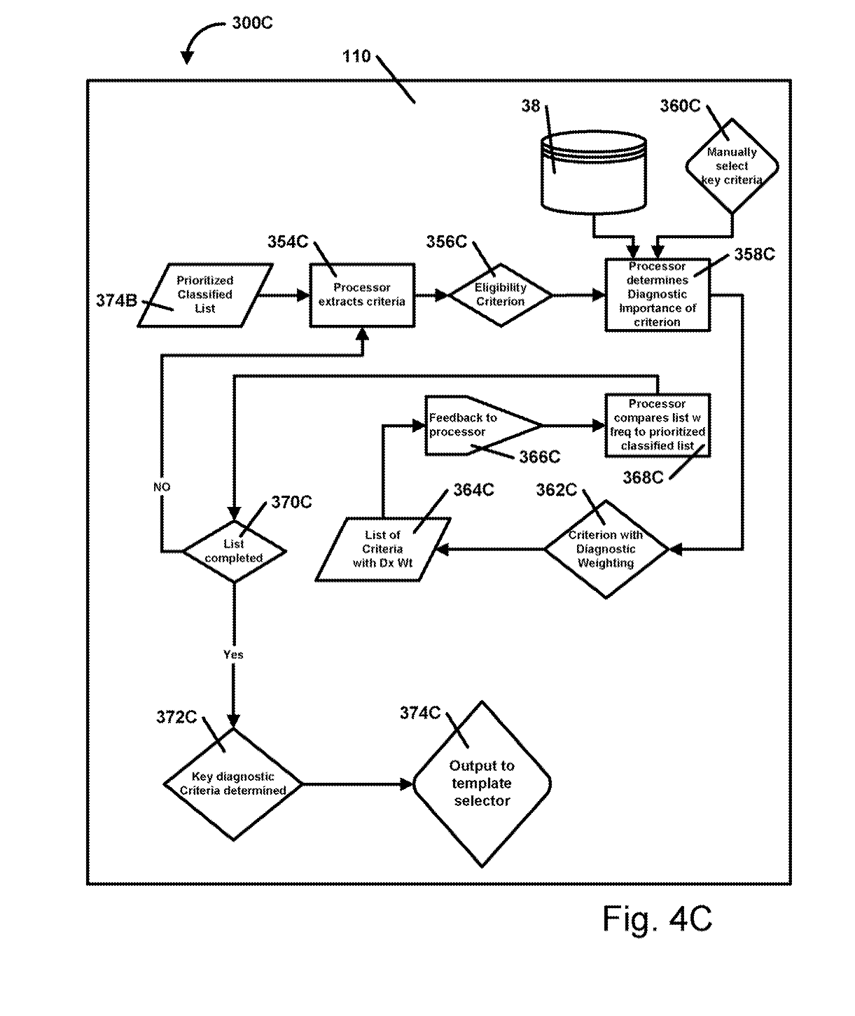

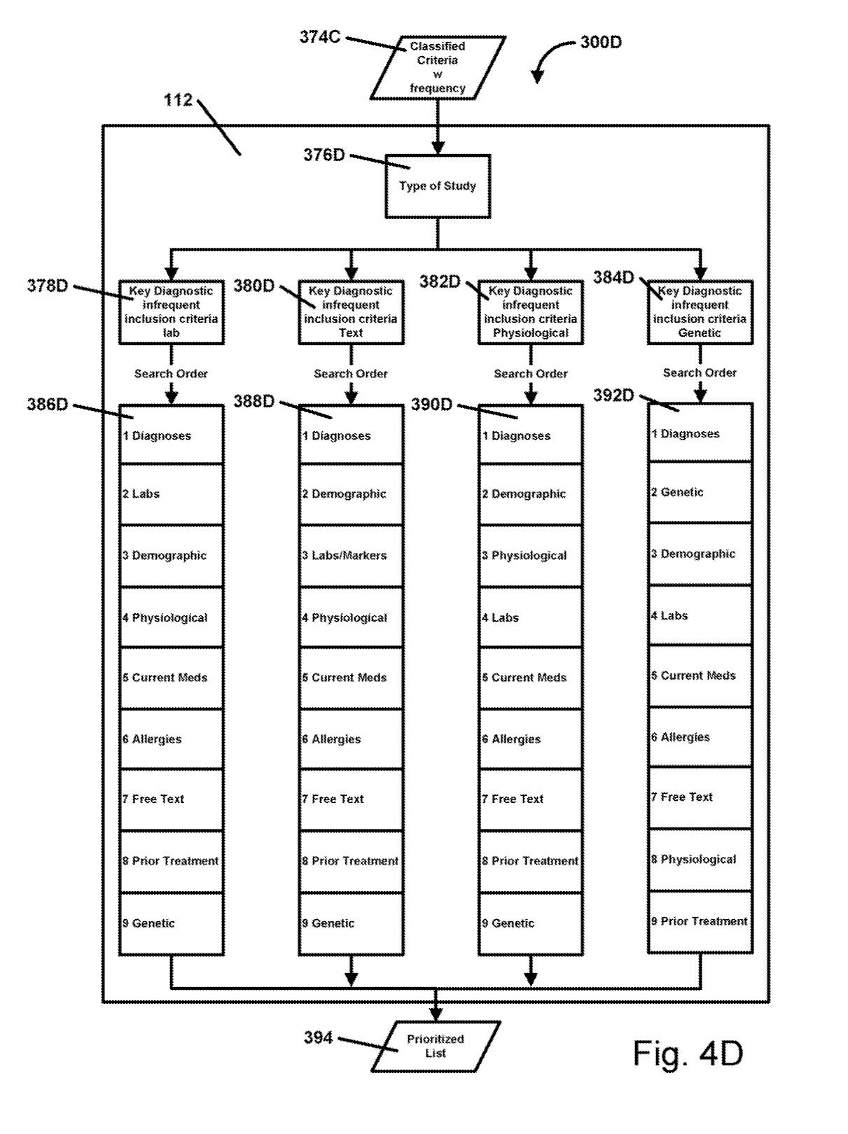

FIG. 4A is a perspective view of a Process to classify eligibility criteria. Referring now to FIG. 4A and to the Examples below, a detailed explanation of the generation of a prioritized list of search criteria will be discussed in detail. This part of the system and method is generally designated by the numeral 300A and describes the specific classifying processes of First Expert System 106. Efficient use of processor time and resources depend on minimizing the number of free text searches. Therefore it can be seen that by matching patients based on other criteria first and free text last, whenever possible, the pool of patients that will be searched for free text criteria will be greatly reduced. This part of the process commences with the input of study eligibility criteria 42 to the processor 30. As the process is iterative, it is a necessary first step 302A to compare the eligibility criteria 42 to a predetermined categorized list of criteria. At the beginning, there will be no matches between the study criteria 42 and the categorized list of criteria. At all times where the prioritized list is incomplete, the match will not be complete and at the next step 306A the processor extracts the first or next criteria. At step 308A, the processor checks to see if the criteria is free text such as dictations of histories and physicals, discharge summaries and progress notes. If the criteria is free text, this information is stored on a separate list of free text criteria 310A, which is then input at step 344A to an updated list of criteria, and summed to create one list of categorized criteria at step 348A. The list of categorized criteria is then fed back to the processor 30 at step 305A to complete one iteration of the cycle. The cycle continues with a new comparison of the eligibility criteria to the list of criteria. If the criteria is not free text, other criteria categories are checked, such as diagnosis at step 312A, demographic data at step 316A, laboratory result at step 320A, allergy at step 324A, current medication patient is taking at step 328A, prior treatments at step 332A, physiological function test result at step 336A and lastly genotype test result at step 340A. Each of the foregoing steps 308A to 340A has a corresponding list 314A, 318A, 322A, 326A, 330A, 334A, 338A, and 342A that is updated depending on which criteria is matched. All the lists are fed into updated lists at step 344A and feedback to the processor at 350A. At step 302A, the processor again compares its master list to the study eligibility criteria 42. Each parameter is examined as described above until all parameters have been examined. When the categorized list matches the study eligibility list, the processor determines that the list is completed at step 304A and then the classified unprioritized list is output to the system 300B at step 352A, to determine the various frequencies of the criteria.

FIG. 4B is a flow chart of step 108 of the process to assign frequencies to each of the criteria and is generally known as the system 300B. Continuing from the output of step 352A the processor 30 at step 354B processes the classified criteria to output at 356B a criteria which is then assigned a frequency at 358B utilizing the method alluded to above at step 108 of FIG. 2, or a neural net or other AI method can be used or the frequencies can simply be input, however the latter is static and as frequencies of criteria vary over time will likely need to be reset frequently. The output is a criterion with its frequency at 362B which is added to a list of criteria with frequencies and fed back to the processor 30 at 366B. At 368B the processor compares the list with frequencies to the list 352A and tries to determine if the list 352 has been exhausted and all criteria assigned frequencies. If the answer is no the process loops back to 354B otherwise it continues to 372 with a completed prioritized classified list which is then output at 374B to the system 300C.

FIG. 4C is a detailed flow chart of step 110 generally designated by 300C and its purpose is to select out that criteria that is the rarest (according to frequency or incidence) yet most easily searchable. It commences at 354C which receives an input from 374B of a completed prioritized classified list of criteria, listed at 356C. Key diagnostic criteria need to be identified weighted and this is done step 358C whereby the processor 30 extracts from a table of diagnostic criteria an inclusion criterion only and at 358C determines its weight. For each disease entity a specific set of diagnostic criteria can be listed on a table in DB 38 to be referred to in order to assign a weight and includes but is not limited to diagnostic criteria for certain diseases, utilizing key diagnostic criteria or a number of “major” and “minor” criteria. Alternatively in other embodiments, the weight can be assigned using a neural net or other AI method or it can be manually set. In particular the processor will compare the criterion to the disease that the study is investigating and will weight criteria according to class with a lab value or marker being the highest weight, ICD 9 or 10 next highest, physiologic the next etc. This order can vary according to the diagnostic criteria and whether a new diagnosis is desired or an established one. The output is 362C a criteria with diagnostic weighting and a list is populated at 364C, fed back at 366C to the processor 30 at 368C and checked for completeness at 370C. If the list is not complete it loops back to 354C otherwise the process outputs a list of weighted key diagnostic criteria to 372C. The top of the list (can be one or more according to the diagnostic criteria) is output at 374C to the system 300D.

FIG. 4D is a perspective view of a Process to sort criteria according to priority based on templates. Referring now to FIG. 4D, this Expert System 112 is generally designated by the numeral 300D. The classified, prioritized list 374C is determined at step 376D to be one of four types of studies. The decision rule is based on the key diagnostic infrequent criteria and determines the search order. It can be a study where most of the inclusion/exclusion criteria are contained in the laboratory criteria such as that shown at step 378D, in which case its corresponding search order is enumerated by the list at 386D. Alternatively, it can have most of the INCLUSION/EXCLUSION criteria in Free Text, as at step 380D, with its corresponding search order 388D. In another alternative, most of the criteria can be physiological, as in step 382D, with its corresponding search order 390D. Lastly, it may be that the predominant criteria are genetic, as in 384D, in which case the priority list at 392D reflects the importance of genetic and allelic data. In all cases a prioritized list is generated at 394 and searches can now commence.

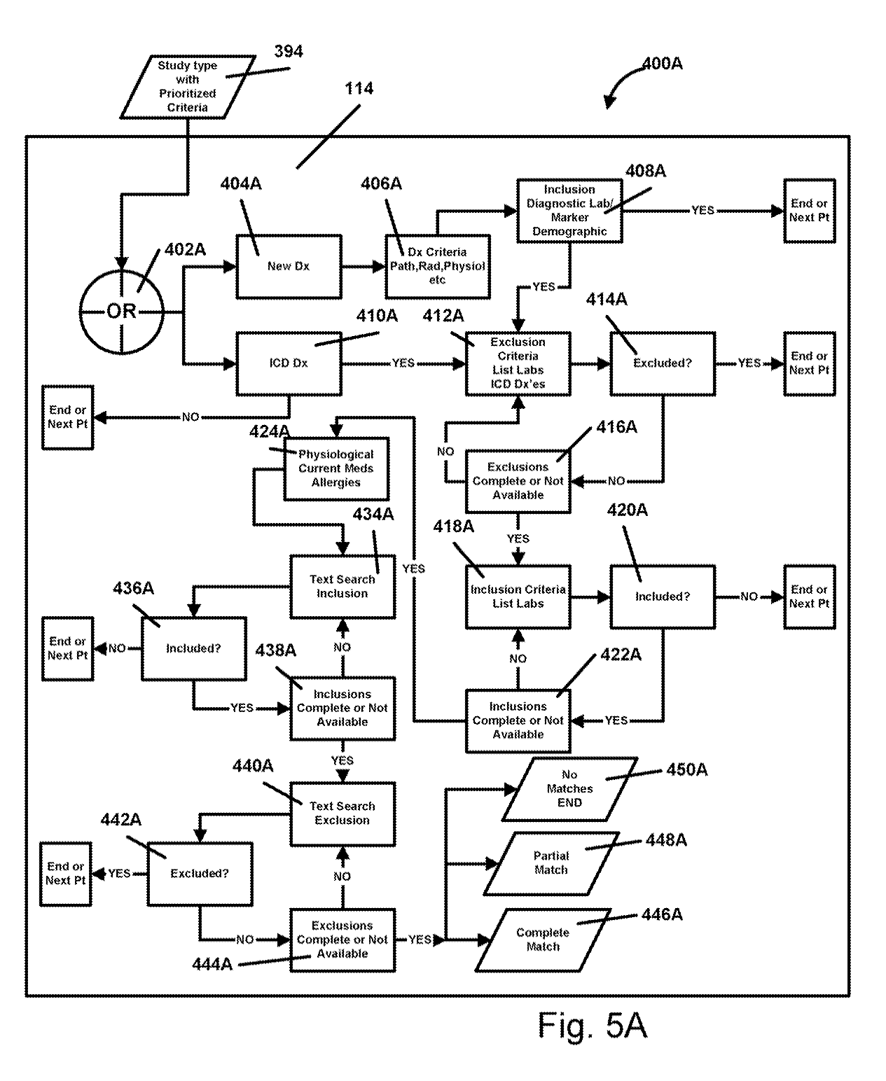

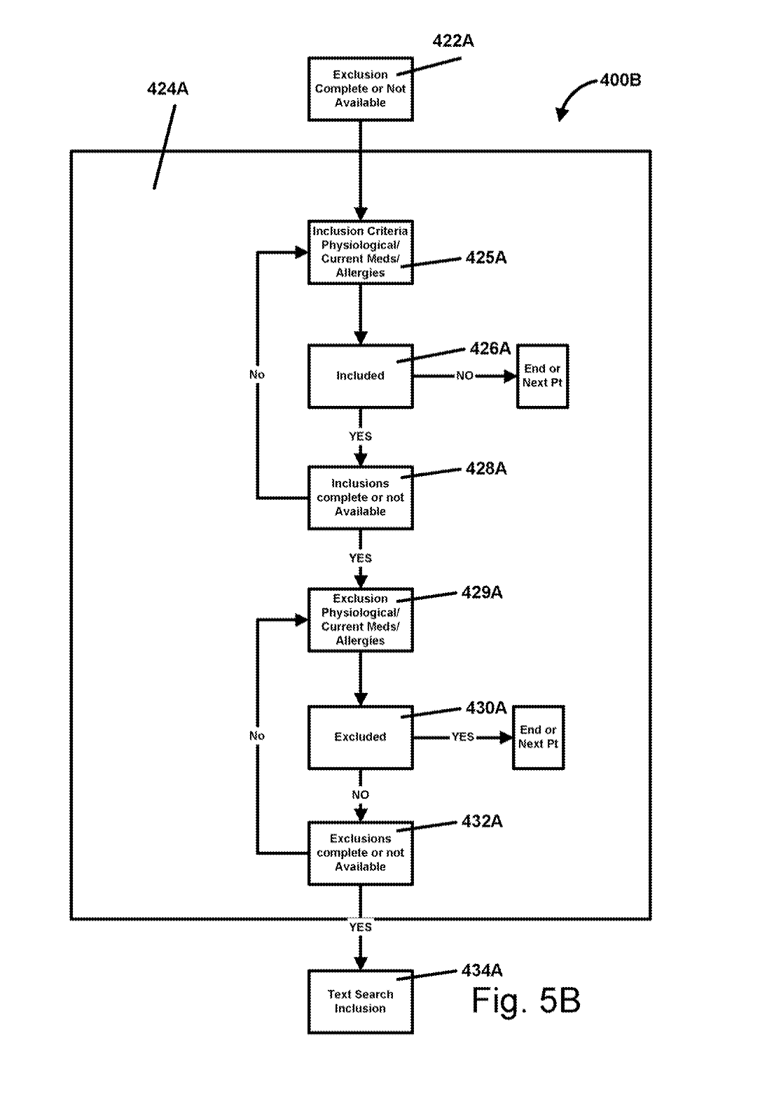

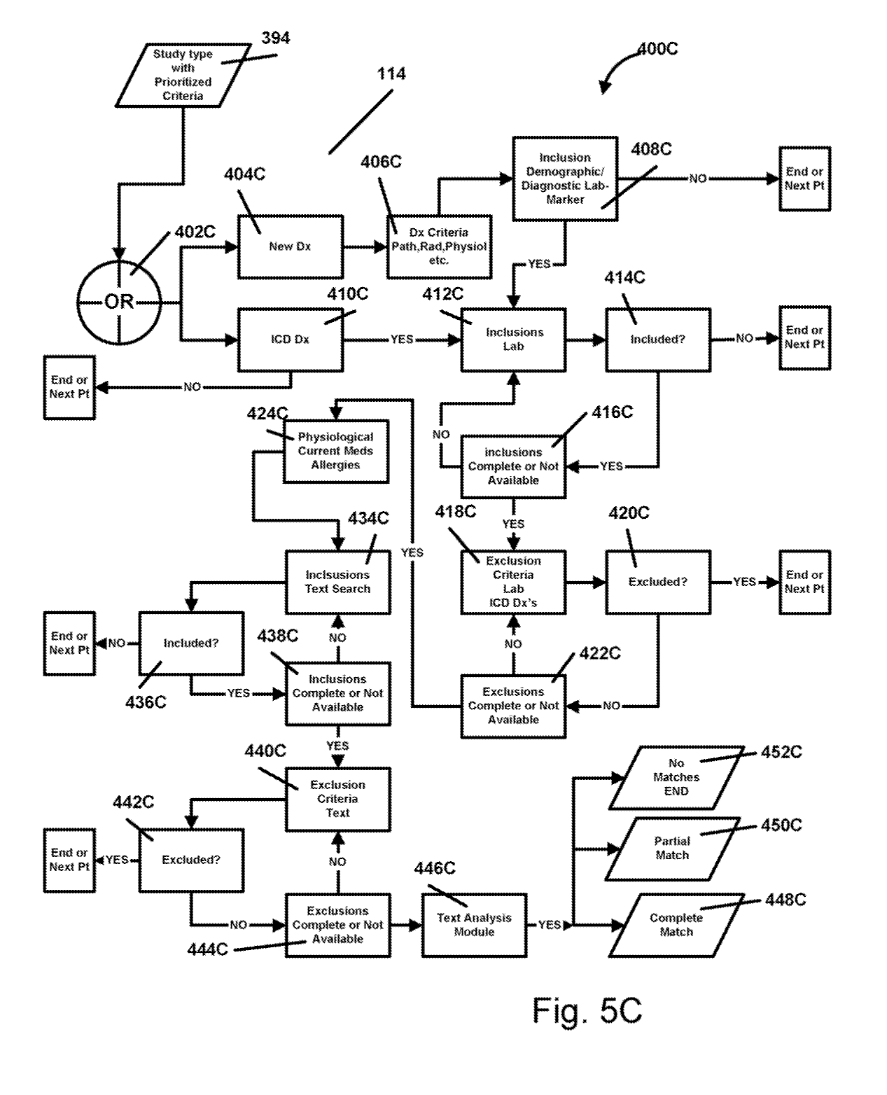

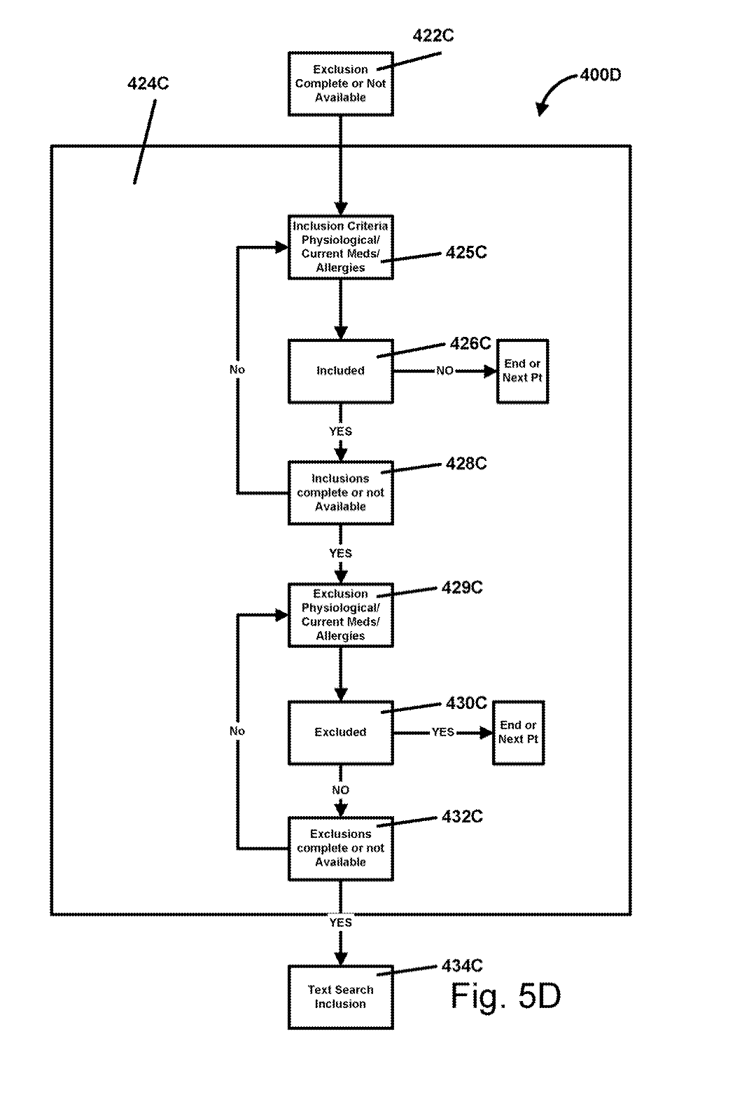

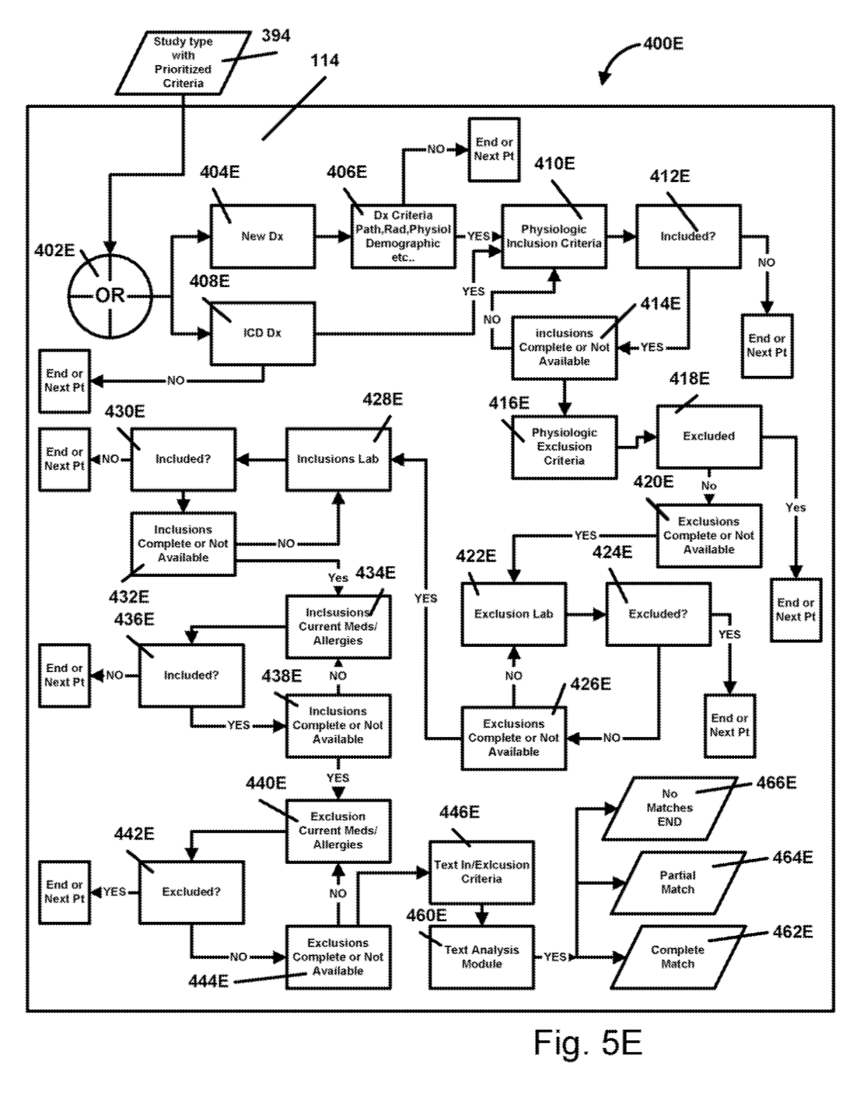

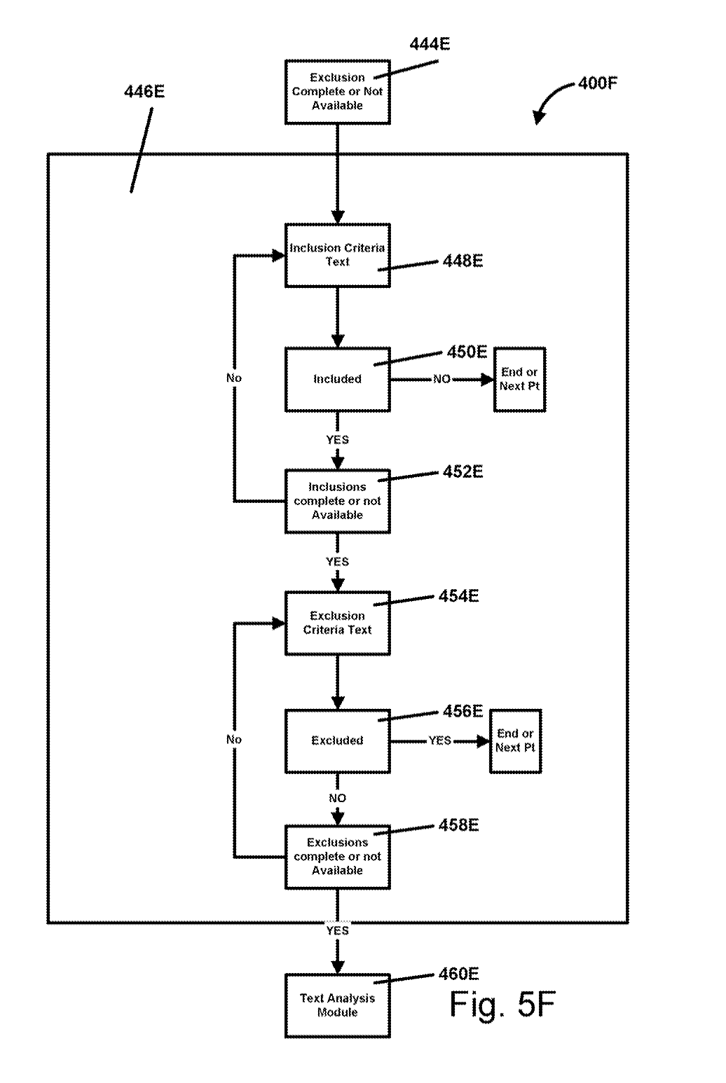

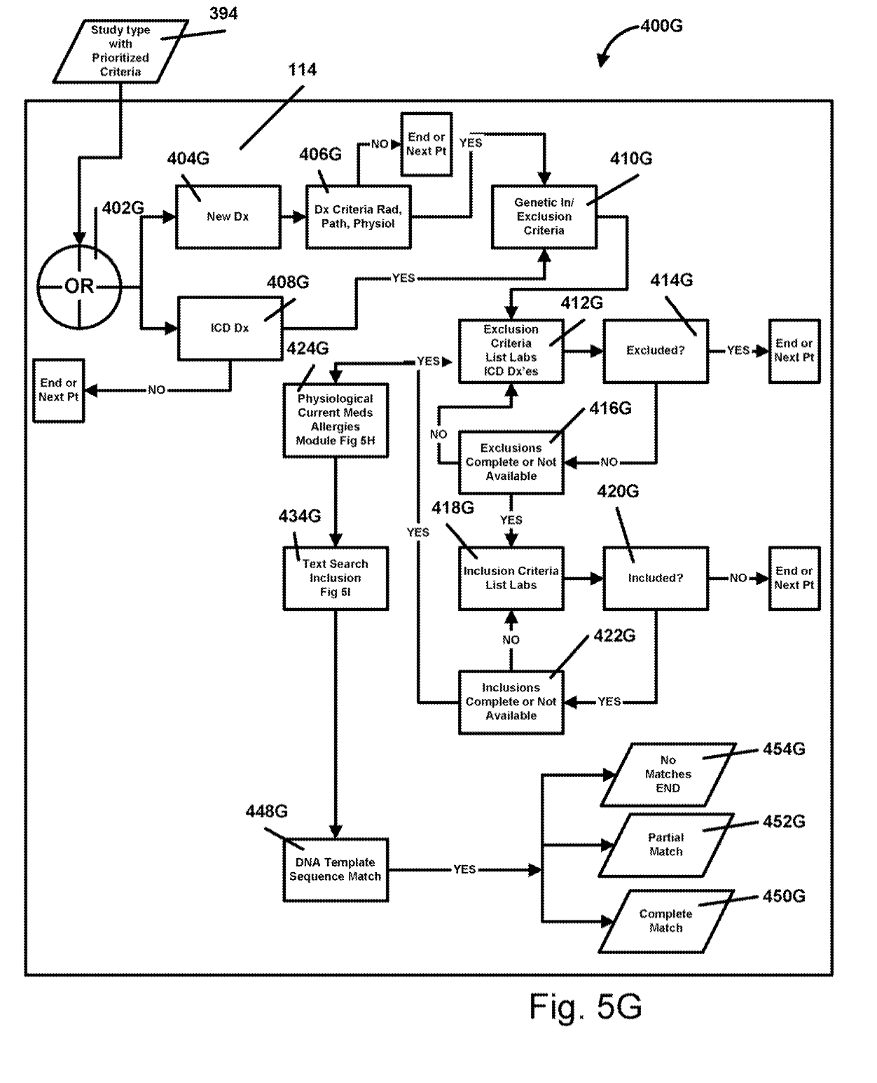

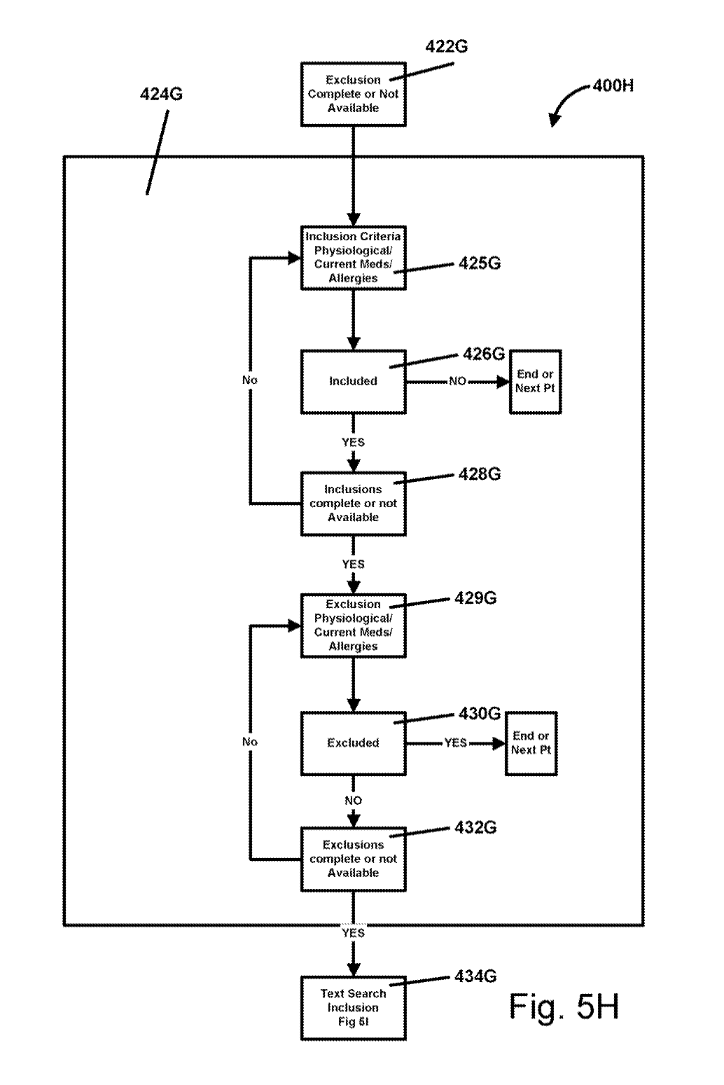

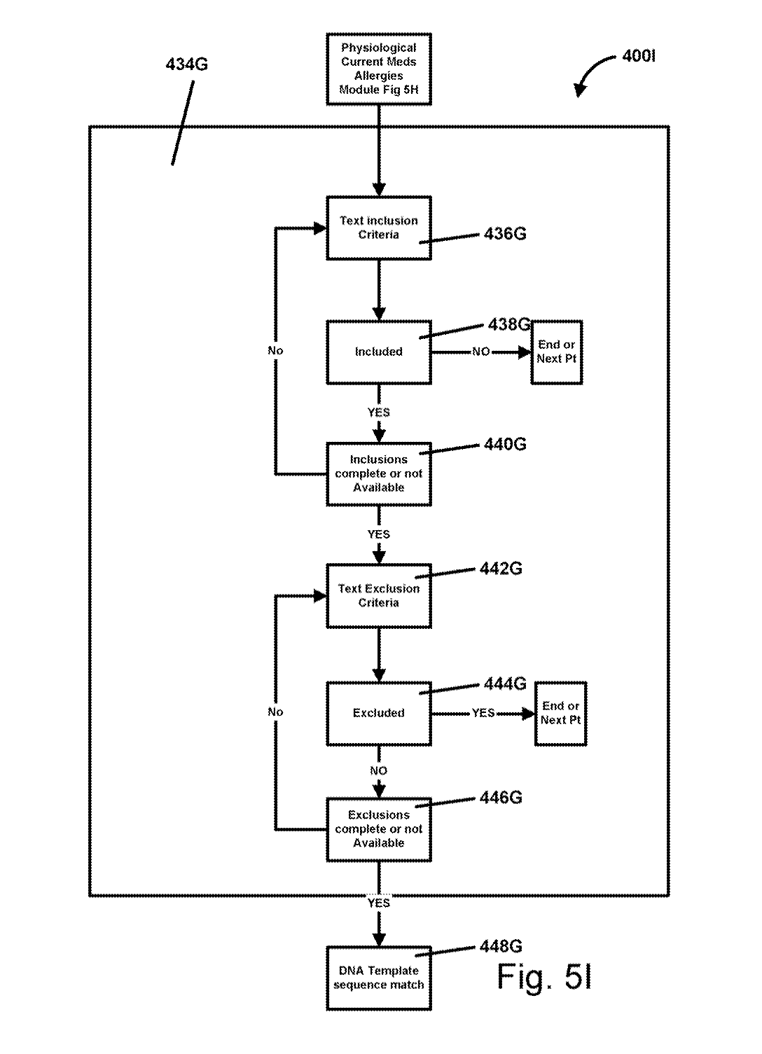

FIG. 5A is a perspective view of a Flow chart of search criteria order for a study that can utilize lab criteria initially. The search process is generally designated by the numeral 400A, 400B, 400C, 400D, 400E or 400F, shown in FIGS. 5A, 5B, 5C, 5D, 5E and 5F, respectively, depending on the predominant search criteria type. If the key diagnostic criteria consist of laboratory tests or markers in INCLUSION/EXCLUSION criteria, the search follows the process of 400A. List 394 is input and examined at step 402A to determine if a new diagnosis is required (step 404A) or if an existing disease is required (step 410A). If a new diagnosis is required, the key diagnostic criteria are examined and it is immediately searched for at step 406A. In particular at step 408A lab markers are checked as well as demographics. If necessary a very limited amount of text can be checked at specified portions of records for string matches, if a new diagnosis is desired and cannot be found by other means. Only those patients whose records match these criteria are retained. Non-matching records are eliminated. If the diagnosis is known step 410A, then a search for an International Statistical Classification of Diseases and Related Health Problems (or ICD) code can be used to retain only those patients with the disease of interest. At step 412A, the list of exclusionary nontextual criteria is populated and then queried at step 412A. If the patient is not excluded, the processor checks to see if the criteria list has been exhausted at step 414A, and if not, it is iteratively utilized for matching at 416A. However, in this case, all matches are removed from the working subset of patients and are utilized in the next search step, leaving those who have not met any exclusions.

When the list has been exhausted, inclusionary laboratory tests are listed at step 418A and checked against A patient record at step 420A. The list is then checked at step 422A to see if it has been exhausted. If not, the remaining patient records are checked again at step 422A and those who remain when the list is exhausted, a still smaller subset of the original, are then sent to step 424A check any physiological/current medication or allergies, see FIG. 5B for an exploded view of steps 424A to 430A. The net results of patients who remain on the list are then sent to the text search inclusion module at step 434A utilizing the text extraction module 112 and later, the text analysis module 118. At step 436A, patients are determined to be included according to the text criteria. Of the subset that remains, the list of textual inclusion criteria is then checked for exhaustion at step 438A and if not exhausted, another text criterion is searched at steps 426A/428A and the patient is determined to be included or excluded. Again, only those patients who are included will be kept in the working subset. The list is then rechecked at step 438A and will recycle iteratively until the text inclusionary criteria list is exhausted. At step 440A, the text exclusionary criteria are searched, the patient is excluded or included at step 442A, and again, the remaining patients of that list are checked for exclusion and the search again iterates until the all of the criteria have been searched. The output of which is either a complete match at step 446A, a partial match at step 448A (because of missing data) or 450A where there are no matches, in which case, the search ends. The entire list of remaining patients is matched to their physicians of record and a report is generated and sent to their corresponding physicians

FIG. 5B is an exploded view of step 424A and is designated by the numeral 400B. After step 422A has been completed the reduced set of patient records are then checked record by record at 425A for physiological/current medications and allergies. At step 426A, if the inclusions are not met that particular record is discarded, otherwise, if inclusions are met the particular record is retained and the list is checked for exhaustion at step 428A. If not then the process iterates back to 425A, otherwise it proceeds to 429A the exclusionary criteria for physiological/current medications and allergies. Similar processes of checking each medical record at 430A for exclusion and either discarding that record or retaining, again checking the lists for exhaustion at 432A. The final step after the lists have been exhausted is the output at step 434A.

FIG. 5C is a perspective view of a Flow Chart of primarily text based criteria for study and is generally designated by the numeral 400C. If the key diagnostic criteria is/are textual and then the search follows the process of 400C shown in FIG. 5C. The list 394 is examined at step 402C to determine if a new diagnosis is required (step 404C) or if an existing disease is required (step 410C). If a new diagnosis is required, the diagnostic criteria are examined at 406C and the processor 30 checks to see if there are any lab or physiological markers that can be checked. If necessary a very limited amount of text can be checked at specified portions of records for string matches at step 408C. Only those patients whose records match these criteria are retained. If the diagnosis is known step 401C, then a search for an ICD code can be used to retain only those patients with the disease of interest. At 412C lab inclusions are listed and checked against patient records at 414C, the subset that are included are checked iteratively at 416C for more inclusion criteria until the list is complete and that subset of patients is checked for exclusionary criteria at 418C. Each patient is compared at 420C for one exclusionary criteria and if not excluded is added to a list of patients. At step 422C the list of exclusions are checked to see if it has been exhausted and if it has the process then obtains the list of physiological/current meds/allergies at 424C, see FIG. 5D for the exploded view. At step 434C the list of inclusionary textual criteria is populated and then queried at step 436C. Again it is a very limited amount of text that is checked at specified portions of records for string matches If the patient is included, the processor checks to see if the list has been exhausted at step 438C, and if not, it is iteratively utilized for matching. However, in this case, all matches are included in the working subset of patients, and those who have not met any inclusions are removed. When the list has been exhausted, exclusionary text criteria are listed at step 440C and checked against patient records at step 442C. The list is checked at step 444C to see if it has been exhausted. If not, the remaining patient records are checked again at step 440C and those who remain when the list is exhausted, a still smaller subset of the original. After the exclusions list has been exhausted, the output of step 444C is passed to the text analysis module at step 446C. The text analysis step is the last step before final matches are output, again, to enhance precision and to complete the searching sequence and to analyze text on the smallest possible subset of patients. The output of step 446C is a complete match at step 448C, a partial match at step 450C (because of missing data) or no match at step 452C, in which case, the search ends. The entire list of remaining patients is matched to their physicians of record and a report is generated and sent to their corresponding physicians.

FIG. 5D is an exploded view of step 424C and is generally designated by the numeral 400D. After step 422C has been completed the reduced set of patient records are then checked record by record at 425C for physiological/current medications and allergies. At 426C if the inclusions are not met that particular record is discarded otherwise, if inclusions are met the particular record is retained and the list is checked for exhaustion at step 428C. If not then the process iterates back to 425C, otherwise it proceeds to 429C the exclusionary criteria for physiological/current medications and allergies. Similar processes of checking each medical record at 430C for exclusion and either discarding that record or retaining, again checking the lists for exhaustion at 432C. The final step after the lists have been exhausted is the output at step 434C FIG. 5E is a perspective view of a Flow Chart for search based on physiological key criteria and is generally designated by the numeral 400E. The sorted prioritized list is examined at step 402E to determine if a new diagnosis is required (step 404E) or if an existing disease is required (step 408E). If a new diagnosis is required, the diagnostic criteria are immediately searched for at step 406E. Only those patients matching these criteria are retained. If the diagnosis is known, then an ICD code search can be used to retain only those patients with the disease of interest. At step 410E the list of inclusionary physiological criteria is populated and then queried at step 412E. It is anticipated that the vast majority will be numeric criteria and include but not be limited to parameters such as pO2 a cardiac output, a heart rate, temperature, blood pressure, but it may require very limited use of the text extraction module 112. If the patient is not excluded, the processor checks to see if the list has been exhausted at step 414E and if not, it is iteratively utilized for matching. However, in this case, all matches are retained in the working subset of patients, removing those who have not met any inclusions. When the list has been exhausted, exclusionary physiological criteria are listed at step 416E and checked against patient records at step 418E. The list is checked at step 420E to see if it has been exhausted. If not, the remaining patients are checked again at step 418E and those who remain when the list is exhausted, a still smaller subset of the original, are then sent to step 422E, where a list of exclusionary laboratory tests are populated and the remaining patient records are examined at step 424E. The subset that remains, that is, those patient records that satisfy one or more of the exclusionary lab test criteria, is checked against the list of inclusion criteria for exhaustion at step 426E and if not exhausted, another criterion is searched at steps 422E/424E and the list rechecked at step 426E. This will cycle until the text exclusionary criteria list is exhausted. At step 428E, the lab inclusionary criteria list is populated, searched at step 430E, and again the remaining patient records are checked for exhaustion at 432E and the search again iterates until the last criteria has been searched. Inclusion Current meds and allergies are checked at 434E, 436E and 438E. When those criteria are exhausted exclusionary current meds and allergies are checked at steps 440E, 442E and 444E. Steps 446E through 458E are described in FIG. 5F. Afterwards the output to Step 448E is the last part where the actual raw text is searched to verify, using contextual and meta-level criteria, the textual criteria that was searched for in steps 448E to 458E, see FIG. 5F. This will be done on a greatly reduced subset of records. The output is sent to 460 for the text analysis module to further extract textual modifier information to complete and check the matches. The output is a match at step 462E, a partial match at step 454E (because of missing data) or no match at step 466E, in which case, the search ends. The entire list of remaining patients is matched to their physicians of record and a report is generated and sent to their corresponding physicians. FIG. 5F is an exploded view of a Flow Chart of step 446E of FIG. 5E. This process utilizes text extraction module 116 and is generally designated by the numeral 400F. Once the list of current meds and allergies exclusions have been exhausted at step 444E, as shown in FIG. 5E, the subset of patients remaining are examined. At step 448E, the text inclusion criteria list is populated and patients are determined to be included or excluded at step 452E. At step 454E the list is check for exhaustion and if not exhausted, the remaining patients are checked for the next criteria on the list at 452E/454E. When the list is exhausted at step 454E the remaining patients are then checked for textual exclusion criteria. The list of textual exclusion criteria is populated at 454E and the remaining subset of patients are checked at step 456E for exclusions. At step 458E the list is checked for exhaustion. If there are remaining criteria to be checked the process iterates at steps 454E and 456E on the ever decreasing subset of patients. The output is sent to 460E for the text analysis module to further extract textual modifier information to complete and check the matches.

FIG. 5G is a perspective view of a Flow Chart for genetic criteria. If the rarest key criterion is genetic then, the search follows the process generally designated by numeral 400G as shown in FIG. 5G. The list 394 is examined at step 404G to determine if a new diagnosis is required (step 402G) or if an existing disease is required (step 408G). If a new diagnosis is required, the diagnostic criteria are immediately searched for at step 406G. Only those patients matching these criteria are retained. If the diagnosis is known, then an ICD code can be used to retain only those patients with the disease of interest. The genetic inclusion/exclusion criteria are checked by the genetic module at step 410G and further detailed in FIG. 5H. At step 412G, the list of exclusionary nontextual laboratory test results/ICD criteria is populated and queried at step 414G. If the patient is not excluded, the processor checks to see if the list has been exhausted at step 416G and if not, it is iteratively utilized for matching. However, in this case, all matches are removed from the working subset of patients leaving those who have not met any exclusions. When the list has been exhausted, inclusionary labs are listed at step 418G and checked at step 420G. The list is checked at step 422G to see if it has been exhausted. If not the remaining patients are checked again at step 418G and those who remain when the list is exhausted, a still smaller subset of the original, are then sent to the physiological inclusion/exclusion module at step 424G see FIG. 5H. The output of that module is to step 434G another module where the lists of textual inclusion/exclusion criteria are then processed see FIG. 5I. Again only those patients who are included will be kept in the working subset. These reduced sets of patients are then searched at step 448G for a genetic data match, such as a DNA sequence match, PCR product match, or restriction fragment length polymorphism (RFLP), for example. The output is either a complete match at step 450G, a partial match at step 452G (because of missing data) or no match at step 454G, in which case, the search ends. The entire list of remaining patients is matched to their physicians of record and a report is generated and sent to their corresponding physicians.

FIG. 5H is an exploded view of step 424G and is designated by the numeral 400H. After step 422G has been completed the reduced set of patient records are then checked record by record at 425G for physiological/current medications and allergies. At step 426G, if the inclusions are not met that particular record is discarded, otherwise, if inclusions are met the particular record is retained and the list is checked for exhaustion at step 428G. If not then the process iterates back to 425G, otherwise it proceeds to 429G the exclusionary criteria for physiological/ current medications and allergies. Similar processes of checking each medical record at 430G for exclusion and either discarding that record or retaining, again checking the lists for exhaustion at 432G. The final step after the lists have been exhausted is the output at step 434G.

FIG. 5I is a perspective view of a Flow Chart for textual criteria exploded and is generally designated by the numeral 400I. The reduced subset from step 432G, shown in FIG. 5H are examined at step 436G, the textual inclusion criteria list is populated and patients are determined to be included or excluded at step 438G. At step 440G, the list is checked for exhaustion and if not exhausted, the remaining patients are checked for the next criteria on the list at steps 436G/438G. When the list is exhausted at step 440F, the remaining patients are then checked for textual exclusion criteria. The list of textual exclusion criteria is populated at 442G and the remaining subsets of patients are checked at step 442G for exclusions. At step 444F, the list is checked for exhaustion. If there are remaining criteria to be checked the process iterates at steps 442G and 444G on the ever decreasing subset of patients. When the list of genetic exclusions is exhausted at 446G, inclusions DNA are checked at step 44GG of FIG. 5G.

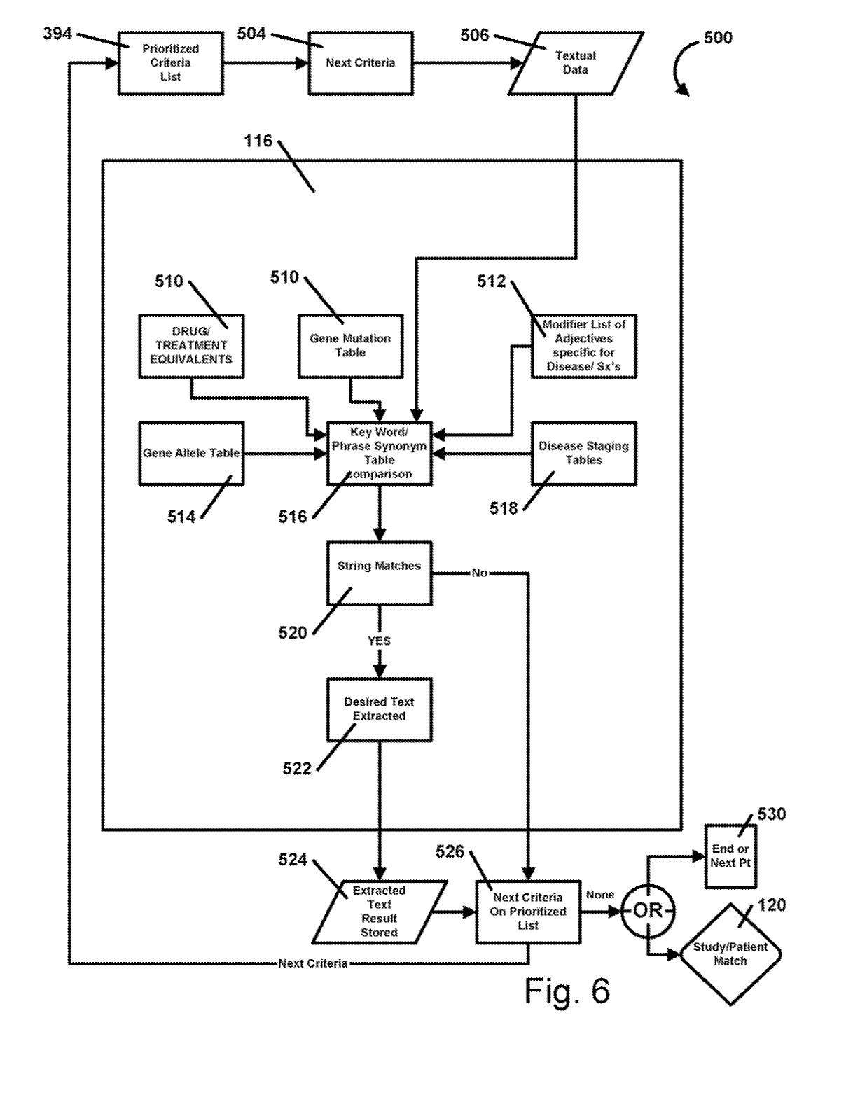

FIG. 6 is a perspective view of a Flow chart of string matching of text criteria. Referring now to FIG. 6 a textual search module is generally designated by the numeral 500. The prioritized list 394 is input and the first or next criteria is selected at step 504 and used to search the textual data at step 506. The text is then searched at 516 for key words or phrases according to a comparison table and utilizes inputs of 5078 drug treatment equivalents, 510 gene mutation table and 514 a gene allele table and 518 a disease staging table. This is then compared for matches at 520 and if the desired text is found, the result is recorded and is kept at 524 if not then the next criteria is checked until the list is exhausted at 526 and either a match is generated at 120 or the patient record is discarded at 530. The textural data is checked against a table of similar diagnoses at step 512 or for similar phrases or against a table 518. The latter will take raw clinical information and classify it into standard disease conditions. Also, a gene allele table 514, which checks for membership in a gene family, may be checked. The relevant criteria together with its appropriate modifiers/staging/gene allele/mutation are compared to the parsed textual data. String matches are checked for at step 520 and if matches are not found, then the next criteria on the list is obtained at step 526 from the list 380 and the search iterates until all of the text criteria are exhausted. If there is a match at step 520, the desired text is extracted and the patient kept in the working subset of patients. When all textual criteria are exhausted, those records that matched the criteria are either output to be searched for other lab criteria or for further text analysis by any commercial text analysis software or output as a list of likely candidates for entry into a clinical trial, as in the latter case all other criteria have been exhausted.

### EXAMPLES

The examples below are lists of study eligibility and exclusion criteria for selected clinical drug trials. A study is listed by the title of the study in bold letters. The category of the criteria for the study is designated in bold brackets [category].

### Example 1

### A Phase II Safety and Efficacy Study of Clarithromycin in the Treatment of Disseminated M. AVIUM Complex (MAC) Infections in Patients with AIDS

### Eligibility

Ages Eligible for Study: 13 Years and above, Genders Eligible for Study: Both Criteria Inclusion Criteria
[CURRENT MEDICATION] Concurrent Medication: Allowed:
Didanosine (DDI).
Dideoxycytidine (ddC).
ZIDOVUDINE (AZT).
Acetaminophen.
ACYCLOVIR.BR PFLUCONAZOLE.
Erythropoietin (EPO).
[DIAGNOSIS] Systemic Pneumocystis carinii pneumonia (PCP) prophylaxis (aerosolized or oral pentamidine, trimethoprim/sulfamethoxazole, or dapsone).
[CURRENT MEDICATION] Maintenance ganciclovir therapy (permitted only if dose and clinical and laboratory parameters have been stable for at least 4 weeks prior to study entry).
[CURRENT MEDICATION] Maintenance treatment for other opportunistic infections if the dose and clinical and laboratory parameters have been stable for 4 weeks prior to study entry. Patients must have:
[LABORATORY RESULT] Positive results for HIV by ELISA confirmed by another method.
[LABORATORY RESULT] Positive blood culture for Mycobacterium avium complex within 2 months of study entry and clinical symptoms of MAC infection.
[FROM FREE TEXT] Discontinued all mycobacterial drugs (approved and investigational) for at least 4 weeks prior to the start of drug therapy (with the exception of ISONIAZID prophylaxis which should be discontinued at Study Day minus 14 to Study Day minus 7)
[THIS WILL BE DONE AFTER THE PATIENT IS COUNSELED AND WILL NOT BE A SEARCH ENGINE CRITERION] Given written informed consent to participate in the trial. Met the listed laboratory parameters in the pretreatment visit.
[TREATMENT HISTORY] Prior Medication: Allowed:
Didanosine (DDI).
Dideoxycytidine (ddC).
ZIDOVUDINE (AZT).
Acetaminophen.
Acyclovir.
Fluconazole.
Erythropoietin (EPO).
[DIAGNOSIS] Systemic Pneumocystis carinii pneumonia (PCP) prophylaxis (aerosolized or oral pentamidine, dapsone, trimethoprim/sulfamethoxazole).
[CURRENT MEDICATION] Maintenance ganciclovir therapy (permitted only if dose and clinical and laboratory parameters have been stable for at least 4 weeks prior to study entry). Exclusion Criteria Co-existing Condition: Patients with the following conditions or symptoms are excluded:
[DIAGNOSIS] Active opportunistic infections. Maintenance treatment for other opportunistic infections will be permitted if the dose and clinical and laboratory parameters have been stable for 4 weeks prior to study entry.
[CURRENT MEDICATION] Concurrent Medication: Excluded:
Aminoglycosides.
Ansamycin (rifabutin).
Quinolones.
Other macrolides.
Clofazimine.
Cytotoxic chemotherapy.
Rifampin.
Ethambutol.
Immunomodulators (except alpha interferon).
Investigational drugs (except ddI, ddC, and erythropoietin).
Patients with the following are excluded:
[ALLERGY] History of allergy to macrolide antimicrobials.
[CURRENT MEDICATION] Currently on active therapy with any anti-MYCOBACTERIAL drugs listed in Exclusion Prior Medications.
[CURRENT MEDICATION] currently on active therapy with carbamazepine or theophylline, unless the investigator agrees to carefully monitor blood levels. Inability to comply with the protocol or judged to be near imminent death by the investigator.
[DIAGNOSIS] Active opportunistic infections.
[DIAGNOSIS] Requiring any of the excluded concomitant medications. prior Medication: Excluded for at least 4 weeks prior to study entry:
[TREATMENT HISTORY] All anti-mycobacterial drugs (approved and investigational) with the exception of isoniazid

### Example 2

### A Phase II Study of Lopinavir/Ritonavir in Combination with Saquinavir Mesylate or Lamivudine/Zidovudine to Explore Metabolic Toxicities in Antiretroviral HIV-Infected Subjects

### Eligibility

[DEMOGRAPHIC] Ages Eligible for Study: 18 Years and above, Genders Eligible for Study: Both Criteria Inclusion Criteria:
[TREATMENT HISTORY] 1. Subject is naive to antiretroviral treatment (subjects may not have more than 7 days of any antiretroviral treatment).
[DEMOGRAPHIC] 2. Subject is at least 18 years of age, inclusive.
[WILL BE CHECKED BY MD AND WILL NOT BE PART OF SEARCH CRITERIA] If female, subject is either not of childbearing potential, defined as postmenopausal for at least 1 year or surgically sterile (bilateral tubal ligation, bilateral oophorectomy or hysterectomy), or is of childbearing potential and practicing one of the following methods of birth control: condoms, sponge, foams, jellies, diaphragm or intrauterine device (IUD), a vasectomized partner, total abstinence from sexual intercourse
[LABORATORY RESULT] If female, the results of a urine pregnancy test performed at screening (urine specimen obtained no earlier than 28 days prior to study drug administration) is negative.
[WILL BE CHECKED BY MD AND WILL NOT BE PART OF SEARCH CRITERIA] Subject is not breast-feeding.
[FREE TEXT FROM PHYSICAL EXAMINATION] Vital signs, physical examination and laboratory results do not exhibit evidence of acute illness.
[DIAGNOSIS]. Subject has no significant history of cardiac, renal, neurologic, psychiatric, oncologic, endocrinologic, metabolic or hepatic disease that would in the opinion of the investigator adversely affect his/her participating in this study.
[CURRENT MEDICATION] Subject does not require and agrees not to take any of the following medications for the duration of the study: midazolam, triazolam, terfenadine, astemizole, cisapride, pimozide, propafenone, flecainide, certain ergot derivatives (ergotamine, dihydroergotamine, ergonovine, and methylergonovine), rifampin, lovastatin, simvastatin, and St. John's wort.
[TO BE PART OF CONSENT AND WILL BE REMOVED FROM SELECTION CRITERIA] Subject agrees not to take any medication during the study, including over-the-counter medicine, alcohol or recreational drugs without the knowledge and permission of the principal investigator.
[DIAGNOSIS] Subject has not been treated for an active AIDS-defining opportunistic infection within 30 days of screening.
[LABORATORY RESULT] Subject has a plasma HIV RNA level of greater than 400 copies/mL at screening.
[TO BE PART OF CONSENT AND WILL BE REMOVED FROM SELECTION CRITERIA] Subject agrees to take all doses of the study drug from the bottles provided by the sponsor (rather than other containers, i. E.,“PILL box”).
[TO BE PART OF CONSENT AND WILL BE REMOVED FROM SELECTION CRITERIA] Subject has voluntarily signed and dated an informed consent form, approved by an Institutional Review Board (IRB)/INDEPENDENT Ethics Committee (IEC), after the nature of the study has been explained and the subject has had the opportunity to ask questions. The informed consent must be signed before any study-specific procedures are performed. Exclusion Criteria:
[ALLERGY] Subject has a history of an allergic reaction or significant sensitivity to LPV/R, INV or Combivir.
[DIAGNOSIS] Subject has a history of substance abuse or psychiatric illness that could preclude adherence with the protocol.
[LABORATORY RESULT] Screening laboratory analyses show any of the following abnormal laboratory results: hemoglobin>10.0 g/dL Absolute neutrophil count>1000 CELLS/μL platelet count >50,000 per mL. ALT or AST<3.0×Upper Limit of Normal (ULN)-creatinine <1.5×Upper Limit of Normal (ULN)
[TREATMENT HISTORY] Subject has received any investigational drug within 30 days prior to study drug administration.
[TO BE DETERMINED BY RESEARCH; SITE] For any reason, subject is considered by the investigator to be an unsuitable candidate for the study EXAMPLE 3: Iressa/Docetaxel in Non-Small-Cell Lung Cancer Eligibility
[DEMOGRAPHIC] Genders Eligible for Study: Both Criteria Inclusion:
[DIAGNOSIS] Pathologically confirmed non-small cell lung cancer.
[DIAGNOSIS] Measurable, evaluable disease outside of a radiation port.
[PHYSIOLOGIC] ECOG performance status 0-2.
[LABORATORY RESULT] Adequate hematologic function as defined by an absolute neutrophil count>=1,500/mm³, a platelet count>=100,000/mm³, A WBC>=3,000/mm³, and a hemoglobin level of >=9 g/dl.
[TREATMENT HISTORY] One prior chemotherapy regimen. This may include CHEMORADIATION treatment.
[FROM FREE TEXT] Disease progression or recurrence within 6 months of last dose of chemotherapy in first chemotherapy regimen.
[TREATMENT HISTORY] At least a 2-week recovery from prior therapy toxicity.
[TO BE DONE WILL BE REMOVED FROM SELECTION CRITERIA] Signed informed consent.
[FROM FREE TEXT] Prior CNS involvement by tumor are eligible if previously treated and clinically stable for two weeks after completion of treatment. Exclusion:
[TREATMENT HISTORY] Prior Iressa or other EGFR inhibiting agents
[TREATMENT HISTORY] Prior docetaxel therapy
[DIAGNOSIS] Other co-existing malignancies or malignancies diagnosed within the last 5 years with the exception of basal cell carcinoma or cervical cancer in situ.
[TREATMENT HISTORY] Any unresolved chronic toxicity greater than CTC grade 2 from previous anti-cancer therapy.
[FREE TEXT FROM DICTATIONS] Incomplete healing from previous oncologic or other major surgery.
[CURRENT MEDICATIONS] Concomitant use of phenytoin, carbamazepine, barbiturates, rifampicin, St John's Wort, anticoagulants.
[LABORATORY VALUE] Absolute neutrophil counts less than 1500×109/liter (L) or 10 platelets less than 100,000×10⁹/liter (L).
[LABORATORY VALUE] Serum bilirubin greater than 1.25 times the upper limit of reference range (ULRR).
[DIAGNOSIS] In the opinion of the investigator, any evidence of severe or uncontrolled systemic disease, (e. g. , unstable or uncompensated respiratory, cardiac, hepatic, or renal disease).
[LABORATORY VALUE] A serum creatinine>=1.5 mg/dl and calculated creatinine clearance<=60 cc/minute.
[LABORATORY VALUE] Alanine amino transferase (ALT) or aspartat amino transferase (AST) greater than 2.5 times the ULRR if no demonstrable liver metastases or greater than 5 times the ULRR in the presence of liver metastasis.
[LABORATORY VALUE] Evidence of any other significant clinical disorder or laboratory finding that makes it undesirable for the patient to participate in the trial.
[TO BE DETERMINED BY CONSENTING MD] Pregnancy or breastfeeding, the patient has uncontrolled seizure disorder, active neurological disease, or Grade>=2 neuropathy
[TREATMENT HISTORY] The patient has received any investigational agent (s) within 30 days of study entry.
[DIAGNOSIS] The patient has signs and symptoms of keratoconjunctivitis sicca or incompletely treated eye infection.

Expected Total Enrollment: 50 As can be seen from the above examples criteria vary widely from one study to the next. Currently there are about 4,000+ studies that are being conducted. In addition, finding patients for these studies searching raw data is like looking for the proverbial “needle in a haystack”.

Based upon the foregoing, the present system can find most if not all of the criteria from patient's Hospital/RHIO records. This can be done faster, accurately and with more up to date information, than by hand searching of charts, advertising, weekly or monthly updates of a centralized database searched via its own search engine. In addition the system will be able to draw upon the practices of large numbers of physicians and Hospital/RHIOs and therefore make available to the general population treatments that might not have previously been available. While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A system for automatically matching patients to clinical trials comprising:
a database component operative to maintain:
one or more medical practice/hospital/RHIO patient database components and
their one or more medical practice/hospital/RHIO databases and their corresponding
plurality of patient names and their medical records, wherein said medical practice/hospital/RHIO patient database components are in communication with one or more medical practice database components and their corresponding plurality of specialties and their corresponding plurality of patient names and their medical records,
a clinical studies database component and its
corresponding plurality of clinical studies;
a communications component to receive changes to said database component; and
a processor programmed to:
periodically match compatible patients and clinical studies without reliance on calculation of probability based inferences of matching, and generate reports to matched medical practices in said medical practice database component having one or more patients matched to at least one clinical study.

2. The system according to claim 1, wherein:
said database component identifies patient names associated with each medical practice in said medical practice database component; and
said processor generates reports to medical practices having identified patients, said reports including a listing of prospective patients for at least one clinical trial.

3. The system according to claim 1, further comprising:
a searching component for searching said clinical studies database component, and said one or more hospital/RHIO patient database components,
wherein said communications component is adaptable to receive searching order instructions.

4. The system according to claim 3, wherein:
said processor is programmed with a rule-based system to vary search parameter priority, wherein said search parameter priority is set to search free text keywords or a phrase in a specified order.

5. The system according to claim 4, wherein:
said search parameter priority is set to search free text keywords or a phrase last.

6. The system according to claim 4, wherein:
Key search criteria are identified and said search order is prioritized, including but not limited to, according to the rarest of said inclusion key search criteria or alternatively the commonest of said exclusion key search criteria.

7. The system according to claim 1, wherein said clinical studies database contains clinical trials selected from the group consisting of clinical drug trials and clinical device trials.

8. A computerized method for matching patients to clinical medical studies comprising:
identifying a group of patients in a medical practice/hospital/RHIO database;
identifying at least one clinical study;
maintaining a database identifying each said patient in said medical practice/hospital/RHIO database and each said clinical study; and
comparing said group of patients in said medical practice/hospital/RHIO database to said
clinical studies and matching one or more patients in a medical practice/hospital/RHIO database to
one or more clinical trials without reliance on calculation of probability-based inferences of matching.

9. The method according to claim 8, further comprising:
maintaining said database to include a plurality of patient profiles associated with a corresponding medical practice; and
notifying a medical practice when at least one of said patient profiles matches the requirements of said clinical studies.
